(19) United States
(12) Patent Application Publication
(10) Pub. No.: US 2026/0142813 A1
(43) Pub. Date: May 21, 2026

(54) Proof-of-Identity (PoI) Consensus Mechanism for Decentralized Ledger Systems

(71) Applicant: LIBERMANS CO., Los Angeles, CA (US)

(72) Inventors: ANNA LIBERMAN WOODFORD, London (GB); DAVID LIBERMAN, Playa Vista, CA (US); DANIIL LIBERMAN, Playa Vista, CA (US); MARIA LIBERMAN, Playa Vista, CA (US)

(73) Assignee: LIBERMANS CO., Los Angeles, CA (US)

(21) Appl. No.: 19/395,238

(22) Filed: Nov. 20, 2025

Related U.S. Application Data
(60) Provisional application No. 63/723,201, filed on Nov. 21, 2024.

(51) Int. Cl. H04L 9/30; H04L 9/32

(52) U.S. Cl. CPC H04L 9/3073; H04L 9/321

(57) ABSTRACT

A Proof-of-Identity (PoI) consensus mechanism which enables secure, decentralized consensus by ensuring that each participating node in the network represents a unique, verified human identity without sole reliance on a central authority. Identity nodes are assigned to participants who have undergone identity verification steps that the network can independently verify. New blocks or records are added to the distributed ledger based on votes from a pseudo randomly selected subset of identity nodes. Each identity node has equal voting power, based on the unique identity it represents, ensuring that voting is not influenced by computational resources or capital holdings. This mechanism aims to achieve a majority representation of honest participants, increasing the security and integrity of the ledger without introducing any centralized governance or control mechanisms.

### CROSS REFERENCE TO RELATED APPLICATIONS

Priority is claimed on Provisional Patent Application No. 63/723,201, filed Nov. 21, 2024, the contents of which are incorporated herein by reference.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

### Not Applicable

### BACKGROUND OF THE INVENTION

### 1. Field of the Invention

The present invention relates to decentralized consensus mechanisms for distributed ledger systems and more particularly to a consensus mechanism based on identity verification called Proof-of-Identity (Pol), which assigns voting weights to nodes based on verified, unique human identities without sole reliance on any centralized authority or control.

### 2. Description of Prior Art Including Information Disclosed Under 37 CFR 1.97 and 1.98

Traditional consensus mechanisms for distributed ledgers, such as Proof-of-Work (PoW) and Proof-of-Stake (PoS), rely on computational power or financial capital to validate transactions and ensure the security of the network. However, these mechanisms come with notable drawbacks:
1. Proof-of-Work (PoW): PoW requires participants to demonstrate computational power, resulting in high energy consumption and significant environmental impact.
2. Proof-of-Stake (PoS): PoS grants voting power based on the amount of cryptocurrency staked, which disproportionately favors wealthier participants and can create centralization risks.

Permissioned blockchain systems attempt to address these issues by pre-selecting trusted nodes, but this approach compromises decentralization by requiring a central authority to designate participants.

This invention introduces an alternative consensus mechanism that uses Proof-of-Identity (Pol), where each participant represents a unique human verified through identity confirmation processes without sole reliance on a central authority. This approach allows for a decentralized, one-person-one-vote consensus system that reduces reliance on computational resources or financial assets, making it more energy-efficient and resistant to centralization while remaining fully independent of centralized governance structures.

### BRIEF SUMMARY OF THE INVENTION

The Proof-of-Identity (Pol) consensus mechanism of the present invention enables secure, decentralized consensus by ensuring that each participating node in the network represents a unique, verified human identity without sole dependence on any centralized validation entity and providing a so-called Sybil-resistant structure that inherently prevents identity duplication or manipulation. Nodes, referred to as “identity nodes,” are assigned to participants who have undergone identity verification steps that the network can independently verify.

New blocks or records are added to the distributed ledger based on votes from a pseudo randomly selected subset of identity nodes. Each identity node has equal voting power, based on the unique identity it represents, ensuring that voting is not influenced by computational resources or capital holdings. This mechanism aims to achieve a majority representation of honest participants, increasing the security and integrity of the ledger through a structure inherently resistant to central authority interference.

### DETAILED SUMMARY OF THE INVENTION

### A Overview of Proof-of-Identity (Pol) Mechanism

### 1. Unique Identity Verification:

Each participant in the Pol-based network must verify their identity to confirm that they represent a unique human. Identity verification methods may include:
   Biometric verification: Fingerprint, facial recognition, or other biometrics.
   Documentation: Government-issued ID or other identifying information.
   Social verification: Endorsements from existing verified participants.
The data provided by a participant for identity verification can be defined in a way so that it can be independently verified by other participants through decentralized cryptographic validation methods. Such data may include hashed representations of identity information that allow verification without revealing sensitive personal details. Each piece of submitted data is cross-validated through network consensus voting, ensuring that authenticity and uniqueness can be confirmed by other participants without reliance on a central authority. This architecture establishes a so-called Sybil-resistant verification framework, enabling transparent yet privacy-preserving validation of human identity. Once submitted, this data goes through the consensus validation process, where other participants vote to confirm or reject the individual's identity based on verifiable criteria. This ensures that no single group, organization, or centralized authority controls the participant list, making the network non-permissioned and fully decentralized.
Once a participant's identity is verified, that participant independently generates a cryptographic key pair consisting of a Private Key and a corresponding Public Key. The participant retains the private key securely and shares the public key with the network, which then, through consensus, assigns a unique Identity Number associated with that public key, and stores the pair in the network's decentralized Identity Ledger.

### 2. Identity Node Creation:

After identity verification, the participant launches a unique identity node on infrastructure under their own control. This node represents the
participant within the network and holds voting rights in the consensus process entirely free from central authority control.
Identity nodes are 1:1 mapped to verified individuals, ensuring that each node corresponds to a unique, real human.

### 3. Voting Weight and Honest Majority:

The Pol system assumes that the majority of verified human participants are honest, allowing a secure majority to drive consensus. This is a one-person-one-vote approach, as each identity node represents an equal voting weight based on identity rather than computational power or financial assets, and without influence from centralized decision-making authorities

### B. Block Generation and Record Addition

In the context of this invention, the term “block” refers to a cryptographically bound collection of validated transactions or records that is added to the distributed ledger as a single, verifiable unit.

### 1. Subset Selection:

For each new record or block added to the ledger, a subset of identity nodes is pseudo-randomly selected. In this context, “pseudo-random” refers to a deterministic selection process derived from publicly available network data, ensuring that the outcome can be independently verified by all participants. This protocol guarantees that no subset of users, including potential malicious actors, can influence or predict the selection in advance, maintaining fairness and resistance to manipulation without centralized scheduling or intervention. This subset selection is deterministic and based on shared network data that is publicly accessible, ensuring transparency and preventing manipulation without any centralized scheduling or intervention.
The selection algorithm ensures that each identity node has an comparable and unbiased probability of selection over time (no single node has greater influence on the selection), preventing any single node from gaining disproportionate influence and ensuring that the process cannot be directed or altered by a centralized entity.
Because identity nodes are selected through a deterministic pseudo-random process, participants can anticipate approximate intervals when their nodes may be called upon for validation. As a result, nodes operated by participants do not need to run continuously, allowing them to remain offline or in standby mode between selection events. This intermittent operation model further increases the energy efficiency of the network and reduces unnecessary computational load, distinguishing Pol from continuously operating consensus mechanisms such as PoW or PoS.

### 2. Validation Process:

Once selected, the subset of identity nodes is responsible for validating the new block or record. Validation involves checking the integrity and authenticity of transactions or data within the block according to predefined network rules that include a deterministic state transition process, ensuring that all participants of the subset update and maintain a consistent ledger state after block acceptance.
Each selected node votes on whether to accept or reject the block. A majority within the subset must approve the block for it to be added to the ledger without oversight or approval from any central coordinator.

### 3. Consensus Agreement:

If the subset majority approves the block, it is permanently recorded on the ledger. This consensus process maintains network integrity by relying on votes from a pseudorandomly selected, representative sample of identity nodes independent of centralized authorities.

### C. Security and Sybil Resistance

### 1. Sybil Attack Prevention:

Since each identity node is tied to a verified human identity, Pol inherently resists Sybil attacks (where attackers create multiple nodes to gain voting control) by blocking duplicate or fake identities during the verification process.
The identity verification process is sufficiently rigorous to significantly limit the registration of stolen or fraudulent identities, with verification open to the network, ensuring decentralized control and independence from any centralized oversight.

### 2. Identity Accountability:

Mechanisms for identity revocation can be implemented to address compromised or disputed identities. If evidence arises that a node represents a fraudulent or compromised identity, network participants can challenge and potentially revoke the identity's voting rights, preserving network integrity through a decentralized governance process without central adjudication.

### D. advantages of Pol Over Existing Mechanisms

### 1. Energy Efficiency:

Unlike PoW, which requires significant computational power, Pol relies on minimal resources to verify identities and manage consensus, making it highly energy-efficient.
   2. lnclusivity:
Pol's one-person-one-vote model eliminates barriers to entry based on computational resources or capital holdings, providing an inclusive consensus mechanism where verified individuals have equal representation without dependence on centralized registries or administrative entities. ln contrast, Proof-of-Stake (PoS) systems impose high economic barriers to participation because network security depends on the total value of assets staked by validators. This creates significant cost overhead for maintaining network integrity, effectively transferring security responsibility to capital holders. Moreover, since capital in such systems tends to concentrate in large wallets, influence over network processes becomes similarly centralized, undermining the principle of decentralization that Pol preserves through identity-based participation.

### 3. Enhanced Security:

By establishing voting power based on unique human identities, Pol offers a closer approximation to democratic governance, which is expected to be more secure under the assumption that a majority of real, verified individuals act honestly and without any central control structure.

### E. Additional Method: Sharding for Increased Throughput Without a Master Chain

### 1. Overview of Sharding:

This invention can be accompanied by an additional method to further enhance throughput in the Proof-of-Identity (Pol) network through sharding without the need for a master chain or any central coordinating authority.
Sharding is a method that divides the network into smaller, independent groups of validators, called shards. Each shard processes its own set of transactions or blocks, allowing multiple transactions to be processed simultaneously across different shards, significantly increasing the ledger's throughput.
In conventional blockchain architectures, however, a master chain (also referred to as a coordinator or beacon chain) is typically required to synchronize shards and ensure network-wide data consistency. The master chain performs key coordination functions such as assigning validators to shards, resolving cross-shard conflicts, providing a unified source of finality, and maintaining the global state of the network. While this mechanism helps ensure consistency, it introduces a layer of centralized orchestration that may become a bottleneck or single point of failure.
In many traditional blockchain architectures, sharding requires a central coordinating chain—often referred to as a master chain, beacon chain or main chain—to coordinate between shards and ensure data consistency. This central chain resolves conflicts, guarantees finality, and synchronizes the network. In contrast, Pol eliminates such centralized orchestration entirely by distributing coordination responsibilities among identity-verified validators using decentralized identity-based mechanisms.

### 2. Sharding Without a Master Chain in Pol:

In the Proof-of-Identity (Pol) system, identity-based voting and pseudorandom subset selection allow for sharding without the need for a master chain and without oversight from any central coordinating authority. Each shard independently selects a pseudorandom group of participants as validators, who process and vote on transactions within that shard.
After validating a transaction or a group of transactions (referred to as blocks), validators within one shard can send relevant messages (signed by the consensus of that shard) directly to validators in other shards. Validators in the receiving shard accept these messages through peer-to-peer trust links, independent of any centralized router or synchronizing node, without the need to synchronize through a master chain, establishing a trust link directly between shards.

### 3. Trust and Security Without a Master Chain:

This shard-to-shard communication is feasible in Pol because each shard's validators are Sybil-resistant, given the identity-based verification process. Pol ensures each shard has a random, honest majority, minimizing the risk of a single shard being controlled by malicious actors.
As each shard's validators can trust that other shards represent an honest consensus, they can exchange validated messages through decentralized, peer-mediated routing mechanisms such as gossip-based propagation or structured overlays (e.g., hypercube), rather than relying on a central coordinating chain. This inter-shard trust emerges organically from decentralized validation rather than from centralized synchronization. While this communication is not strictly point-to-point-since messages are propagated through multiple nodes—it remains fully decentralized and verifiable. This design avoids single coordination bottlenecks but acknowledges that increased redundancy and data multiplication may occur during cross-shard transmission, a trade-off that preserves decentralization at the cost of bandwidth efficiency. This inter-shard trust emerges organically from decentralized validation rather than from centralized synchronization. This design relies on the assumption that no subgroup of malicious actors can control the majority within any randomly selected shard ensuring that cross-shard communication remains secure under decentralized message routing without the intervention of any central entity or coordinator.

### 4. Comparison to PoW and PoS:

In traditional Proof-of-Work (PoW) and Proof-of-Stake (PoS) systems, the assumption of an honest majority applies only to the entire network and does not reliably hold when dividing into separate, unsynchronized shards. As a result, PoW and PoS networks require additional synchronization, often via a central coordinating chain such as a master or beacon chain, to ensure consistency and security across shards. Even in sharded implementations, final verification and consensus finality must still occur at the level of the coordinating chain, since validator subgroups within individual shards cannot be fully trusted to maintain global consistency on their own. This hierarchical validation structure introduces latency, additional complexity, and partial centralization of control that Pol's identity-based model avoids.
In contrast, Pol's unique structure allows each shard to function as a Sybil-resistant, trustworthy subgroup, much like how society relies on random juries. This trust in random subgroups enables direct communication between shards without a master chain, dramatically increasing transaction throughput. The absence of centralized orchestration not only enhances scalability but also preserves the network's fundamental decentralization principles, ensuring that every shard operates autonomously yet cooperatively within a self-governing ecosystem.

### F. Additional Method: Address Book for Secure and Efficient Communication

This invention introduces an address book maintained by consensus and operating without central coordination, ensuring that all communication references and cryptographic records remain decentralized and self-verifying across the network.

### 1. Gossiping in Decentralized Networks:

In modem blockchain and other decentralized networks, goss1pmg (or addressed gossiping) is a common method for relaying messages between nodes. Gossiping is a decentralized communication protocol where each node periodically communicates with a subset of other nodes, relaying messages throughout the network. Addressed gossiping specifically targets certain nodes for communication rather than using a purely random distribution.
In an ideal setting, validators within a shard would have a subnetwork for direct communication to improve efficiency. However, gossiping alone does not guarantee secure, direct communication and can be inefficient as messages propagate through multiple nodes. Because each node forwards a message to multiple peers, the same data is propagated repeatedly across the network. This multiplicative relay pattern causes significant message redundancy, which in large-scale environments turns communication itself into a bandwidth bottleneck. Moreover, traditional implementations sometimes rely on semi-centralized relay points or routing optimizations, which Pol intentionally avoids to maintain complete decentralization.

### 2. Address Book Mechanism:

This invention introduces an additional method to improve communication by implementing an address book within the ledger maintained entirely by decentralized consensus without reliance on any central registry or communication server. This address book is maintained by the consensus of participants and serves as a secure directory that records network addresses of other participants, as well as optionally their public keys.
Each record in the address book is consensus-verified and contains cryptographic proofs, ensuring that the information can be trusted without validation from a centralized directory service. When shared between nodes, this verified data allows nodes to establish direct communication channels independent of central routing authorities, without fear of connecting with an incorrect or malicious participant.

### 3. Application in Sharded and Non-Sharded Networks:

If sharding is implemented, this address book method can be used by nodes both within a shard and for cross-shard communication. Validators within a shard can refer to the address book to establish direct, secure communication with other validators in their shard. Similarly, for cross-shard communication, validators can refer to verified address records to initiate direct connections with validators in other shards without routing through any centralized control infrastructure.
By enabling trusted, direct communication channels, the address book mechanism reduces the reliance on gossiping protocols, improving communication efficiency across the network while preserving complete autonomy from centralized messaging systems.

### 4. Benefits of the Address Book for Throughput:

The address book method significantly improves the speed of node-to-node communication by eliminating unnecessary message relays and reducing communication latency. This approach also decreases the overall bandwidth required for data exchange, often by several multiples, since messages are transmitted only between verified and directly addressable peers rather than being redundantly broadcast through the entire network. This efficiency increase further enhances the ledger's throughput, enabling a higher number of transactions to be processed by the network without introducing centralized bottlenecks or coordination points.

### 6. Potential Embodiments and Implementations

Pol can be implemented in various distributed ledger environments, including:
1. Decentralized Applications (dApps): Pol can serve as the consensus mechanism for applications requiring high user verification standards, such as decentralized voting systems or identity verification networks that function without centralized authority.
2. Public Blockchains: Pol can be used to power public blockchains where inclusive, democratic governance is preferred over resource-based models. The utilization of Pol in such networks is not merely advantageous from a governance standpoint but constitutes a substantive improvement in system scalability and performance. Specifically, by reducing consensus overhead and enabling parallelized validation pathways, Pol can support throughput on the order of millions of transactions per second (TPS) while maintaining decentralized trust and verifiable integrity across all participating nodes.
3. Permissioned Blockchains: In permissioned networks where identity verification is paramount, Pol enables the fair distribution of voting rights among participants
while maintaining decentralization and avoiding centralized administrative control.

### 7. Conclusion

The Proof-of-Identity (Pol) consensus mechanism is a novel approach to decentralized ledger consensus. By assigning voting power based on verified unique human identities without any centralized oversight or control, Pol reduces reliance on computational or capital resources and creates a more energy-efficient, secure, and inclusive consensus system. This mechanism promises to maintain the integrity and security of distributed ledgers through a decentralized, one-person-one-vote structure. The independent identity verification process and consensus-based voting on identity eligibility ensure that the network remains permissionless, further enhancing decentralization and security.

In addition, this invention can be accompanied by a sharding approach that bypasses the need for a master chain, enabling independent shards with pseudorandom groups of validators. Each shard can trust messages from other shards directly, without central coordination, significantly increasing the ledger's throughput by allowing parallel transaction processing.

Furthermore, this invention can include an address book mechanism that securely records network addresses and public keys of participants, maintained by consensus within the ledger. This address book enables nodes to establish trusted, direct communication channels both within and across shards, reducing reliance on gossiping protocols and further increasing the network's transaction processing throughput.

While only a limited number of preferred embodiments of the present invention has been disclosed for purposes of illustration, it is obvious that many modifications and variations could be made thereto. It is intended to cover all of those modifications and variations which fall within the scope of the present invention, as defined by the following claims.

1. A decentralized consensus mechanism based on identity verification which assigns voting weights to nodes based on verified, unique human identities in decentralized ledger system, comprising assigning a unique, verified human identity for each participating node in the network without reliance on a central authority or centralized control, wherein each identity node represents an equal voting weight based on identity, and new blocks or records are added to the distributed ledger based on votes from a pseudo randomly selected subset of identity nodes, wherein a subset of identity nodes is responsible for validating the new block or record and wherein the validation involves checking the integrity and authenticity of transactions or data within the block according to predefined network rules independent of any central coordination.

2. The mechanism of claim 1 further comprising a sharding mechanism including multiple independent groups of validators to validate multiple transactions simultaneously across different shards free from centralized orchestration, with or without requiring a master chain, wherein each of said shards operates independently using identity-based voting and pseudorandom validator selection.

3. The mechanism of claim 1 further comprising a decentralized address book which improves network communication by maintaining verified participant records, enabling secure direct messaging and reducing reliance on inefficient gossiping without any central communication hub.

4. The mechanism of claim 2 further comprising a decentralized address book which improves network communication by maintaining verified participant records, enabling secure direct messaging between validators of shards and reducing reliance on inefficient gossiping while remaining independent of centralized coordination.

5. The mechanism of claim 1 wherein identity verification comprises one or more of biometric, documentation and social verification conducted in a decentralized manner without oversight from a central authority.

6. The mechanism of claim 1 wherein said subset of identity nodes is responsible for validating the new block or record.

7. The mechanism of claim 6 wherein the validation involves checking the integrity and authenticity of transactions or data within the block according to predefined network rules defined and agreed upon by decentralized participants.

8. The mechanism of claim 2 wherein each of said shards operates independently using identity-based voting and pseudorandom validator selection, eliminating the need for a master chain or centralized synchronizing component.

9. The mechanism of claim 1 wherein data provided by a participant for identity verification is defined to be independently verified by other participants.

10. The mechanism of claim 9 wherein, once submitted, said data goes through the consensus validation process, where some participants (a subset of network participants) vote to confirm or reject the individual's identity based on verifiable criteria.

11. The mechanism of claim 10 wherein no single group or authority controls the participant list, making the network non-permissioned and fully decentralized and independent from centralized governance.

12. The mechanism of claim 10 wherein, once verified, participant generates Private Key and corresponding Public Key, wherein a unique Identity Number is generated by the network through consensus and the Public Key is assigned by the network to the participant's identity and the pair recorded in the network's decentralized Identity Ledger, while the Private Key remains securely stored with the participant without being held by any central authority.

13. The mechanism of claim 1 wherein, upon achieving a predetermined level of confidence in identity verification, a unique identity node is created for each verified participant and said node represents the participant within the network and holds voting rights in the consensus process free from central administrative control.

14. The mechanism of claim 13 wherein said identity nodes are 1:1 mapped to verified individuals, ensuring that each node corresponds to a unique, real human.

15. The mechanism of claim 14 wherein the majority of verified human participants are assumed to be honest, allowing a secure majority to drive consensus.

16. The mechanism of claim 1 wherein, for each new record or block added to the ledger, a subset of identity nodes is pseudo-randomly selected based on shared network data that is publicly accessible, ensuring transparency and preventing manipulation.

17. The mechanism of claim 1 further comprising a selection algorithm that ensures the selection of identity nodes is fairly distributed over time (no single node has enhanced influence), preventing any single node from gaining disproportionate influence.

18. The mechanism of claim 1 wherein, once selected, the subset of identity nodes is responsible for validating the new block or record.

19. The mechanism of claim 1 wherein validation involves checking the integrity and authenticity of transactions or data within the block according to predefined network rules that are collectively governed by decentralized participants.

20. The mechanism of claim 1 wherein each selected node votes on whether to accept or reject the block and a majority within the subset must approve the block for it to be added to the ledger.

21. The mechanism of claim 20 wherein, if the subset majority approves the block, it is permanently recorded on the ledger.

22. The mechanism of claim 1 further comprising a sharding mechanism wherein each shard processes its own set of transactions or blocks and maintains only the portion of the ledger corresponding to the accounts relevant to that shard, thereby, allowing multiple transactions to be processed simultaneously across different shards, significantly increasing the ledger's throughput.

23. The mechanism of claim 1 further comprising a sharding mechanism wherein identity-based voting and pseudorandom subset selection allows for sharding without the need for a master chain and each shard independently selects a pseudorandom group of participants as validators, who process and vote on transactions within that shard.

24. The mechanism of claim 1 further comprising a sharding mechanism wherein, after validating a transaction or a group of transactions (referred to as blocks), validators within one shard can send relevant messages (signed by the consensus of that shard) directly to validators in other shards and wherein said validators in the receiving shard accept these messages without the need to synchronize through a master chain, establishing a trust link directly between shards.

25. The mechanism of claim 3 wherein said wherein messages between nodes can be relayed by a decentralized communication protocol where each node periodically communicates with a subset of other nodes, relaying messages throughout the network.

26. The mechanism of claim 1 further comprises implementing an address book within the ledger, wherein said address book is maintained by the consensus of participants and serves as a secure directory that records network addresses of other participants, as well as optionally their public keys.

27. The mechanism of claim 26 wherein each record in said address book is consensus-verified and contains cryptographic proofs, and when shared between nodes, this verified data allows nodes to establish direct communication channels without fear of connecting with an incorrect or malicious participant.

28. The mechanism of claim 27 wherein, if sharding is implemented, said address book method can be used by nodes both within a shard and for cross-shard communication, wherein validators within a shard can refer to the address book to establish direct, secure communication with other validators in their shard and for cross-shard communication, validators can refer to verified address records to initiate direct connections with validators in other shards.
